(19) United States
(12) Patent Application Publication
(10) Pub. No.: US 2013/0174033 A1
(43) Pub. Date: Jul. 4, 2013

(54) HTML5 Selector for Web Page Content Selection

(71) Applicants: Simon Hanukaev, Holon (IL); Ohad Eder-Pressman, San Francisco, CA (US); Vincent Le Chevalier, San Jose, CA (US); Charles F. Geiger, San Jose, CA (US)

(72) Inventors: Simon Hanukaev, Holon (IL); Ohad Eder-Pressman, San Francisco, CA (US); Vincent Le Chevalier, San Jose, CA (US); Charles F. Geiger, San Jose, CA (US)

(73) Assignee: Chegg, Inc., Santa Clara, CA (US)

(21) Appl. No.: 13/476,985

(22) Filed: May 21, 2012

Related U.S. Application Data
(60) Provisional application No. 61/581,562, filed on Dec. 29, 2011.

(51) Int. Cl. G06F 3/01; G06F 15/16; G06F 17/00

(52) U.S. Cl. 715/273; 715/747

(57) ABSTRACT

An education digital reading platform provides HTML5 pages to a user's computing device to enable a browser executing on the user device to display it. Words, lines, paragraphs and columns on the page are identified to enable a user to easily select one or more words within the displayed page. Additionally, custom tools are provided to the user to enable the user to interface with the selected words. For example, a user is provided with customizable magnification and highlight tools, wherein the user can choose custom magnification levels and custom highlight colors. The tools advantageously enable a user perform such actions on the page without accessing the operating system resources on a computing device.

### CROSS REFERENCE TO RELATED APPLICATIONS

This application claims priority to U.S. Provisional Application No. 61/581,562, which is incorporated by reference in its entirety.

This application is related to U.S. Utility application Ser. No. 13/253,011, which is incorporated by reference in its entirety.

### BACKGROUND

1. Field of the Invention

This invention relates to enabling users to select content in documents in HTML5 format and provided by an educational platform.

2. Description of the Related Art

The successes of commercially deployed devices offering electronic book content and services provide an indication that readers at large were ready to migrate from print to digital content. Furthermore, consumer adoption has been validated across a wide distribution of gender, age and geography as this shift accelerated all around the world.

The emergence of HTML5 based platforms is now offering an alternate system and method for the distribution, protection and consumption of copyrighted documents. Most noticeably, where other document formats, such as ePub or PDF for example, require the entire document to be downloaded and extracted before being made available to proprietary eReading applications, HTML5 based platforms only need to download individual pages or blocks of pages of a document, thus defining a flexible and dynamic model to the otherwise traditional monolithic content distribution and consumption model.

But differences in HTML5 browser implementation and overall performance are creating particular technical challenges to the implementation of content selection and deployment of unified user experience from a service provider perspective. Specifically, the challenges in implementing content-selection in an HTML5 environment are a product of the limited resources, computation capacity and interaction limitations imposed by web browsers and operating systems. For example, operating systems typically do not allow a web browser application to access native resources to highlight or magnify text of a document displayed by the web browser. As such, users of HTML5 are unable to meaningfully interact with HTML5 documents displayed on web browser applications.

### SUMMARY

As such, embodiments of the invention enable a user to interact with an HTML5 document displayed on a web browser application executing on a computing device such as a computer, a tablet computer, an ereading device, a mobile phone, etc. Typically, web browsers do not have access to native resources that are available on an operating system; as such, web browsers do not offer a functionality enabling users to interact with a document displayed on the browser by highlighting it or magnifying text within the document. Embodiments described herein enable such functionality without accessing the operating system resources on a computing device.

Embodiments of the invention provide a method for selecting text on a document displayed by a web browser application. The method comprises intercepting a user input directed to text displayed within the web browser application, wherein the user input is generated responsive to a user interaction with an input device of a computing device. Additionally, the method comprises interpreting the user input and identifying input boundary conditions responsive to the interpreted input. A boundary condition may provide a location or a coordinate of the user input. The method also comprises selecting words associated with the user input based on the identified boundary conditions and displaying a user interface providing custom functionality offered by a web browser application to enable the user to interact with a document by highlighting it or magnifying one or more words displayed within the document.

Embodiments of the invention also include a computer program product with instructions for selecting text on a document displayed by a web browser application. The instructions comprise intercepting a user input directed to text displayed within the web browser application, wherein the user input is generated responsive to a user interaction with an input device of a computing device. Additionally, the computer program product comprises instructions for interpreting the user input and identifying input boundary conditions responsive to the interpreted input. A boundary condition may provide a location or a coordinate of the user input. The computer program product also comprises instructions for selecting words associated with the user input based on the identified boundary conditions and displaying a user interface providing custom functionality offered by a web browser application to enable the user to interact with a document by highlighting it or magnifying one or more words displayed within the document.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates a block diagram of a computing device configured to enable a user to select portions of an HTML5 document displayed in an application executing on the computer in accordance with an embodiment of the invention.

FIG. 2 is a block diagram illustrating an example computing device in accordance with an embodiment of the invention.

FIG. 3 is a block diagram illustrating modules within a selection module in accordance with an embodiment of the invention.

FIG. 4 is a block diagram illustrating modules within HTML5 custom tool modules in accordance with an embodiment of the invention.

FIG. 5 is an illustration of selecting content on an HTML5 page by pressing and holding in accordance with an embodiment of the invention.

FIG. 6 is an illustration of a selecting content on an HTML5 page by touching and dragging in accordance with an embodiment of the invention.

FIG. 7 is an illustration of selecting content on a multi-columned HTLM5 page in accordance with an embodiment of the invention.

FIG. 8 is a diagram illustrating a process of selecting content responsive to touch input in accordance with an embodiment of the invention.

FIG. 9 is a diagram illustrating a process of selecting content responsive to a mouse input in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### Computing Device

Embodiments of the invention enable a user to interact with an HTML5 document displayed on a web browser application executing on a computing device such as a computer, a tablet computer, an ereading device, a mobile phone, etc. Typically, web browsers do not have access to native resources that are available on an operating system; as such, web browsers do not offer a functionality enabling users to interact with a document displayed on the browser by highlighting it or magnifying text within the document. Embodiments described herein enable such functionality without accessing the operating system resources on a computing device.

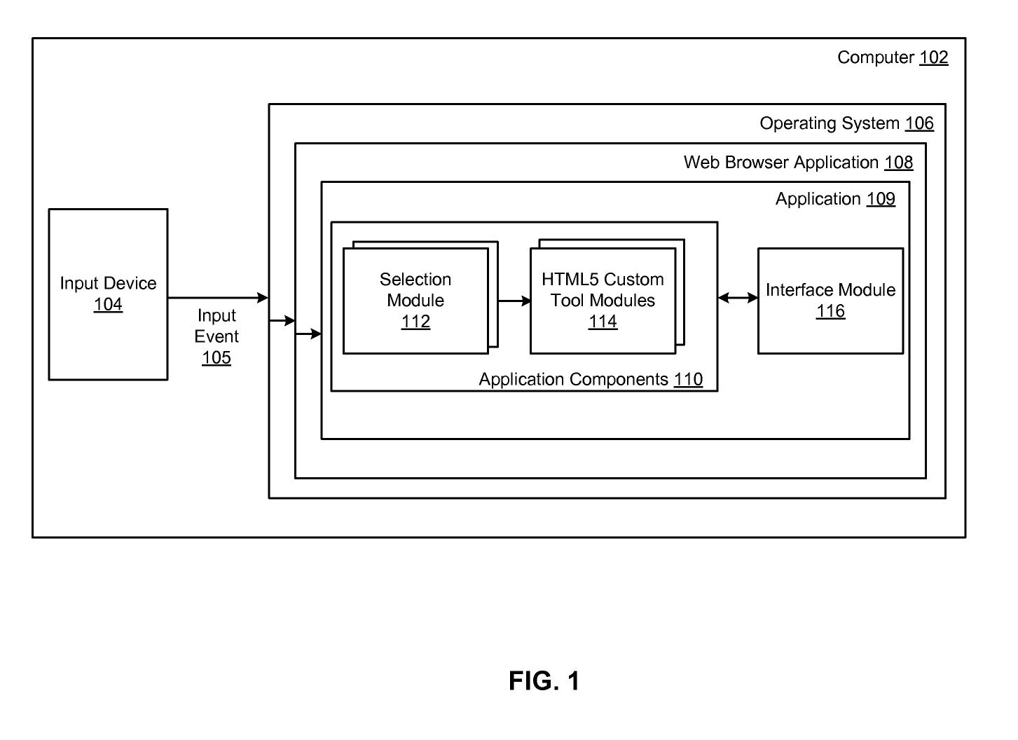

FIG. 1 illustrates a block diagram of a computing device configured to enable a user to select portions of an HTML5 document displayed in an application executing on the computer in accordance with an embodiment of the invention. At a high level, a user uses the input device 104 to select a portion of text displayed on a web browser application 108 displaying an HTML5 document and wherein an application 109 receives the user input and identifies the text the user intended to select and offers custom tools to enable the user to interact with the selected text. As such, embodiments of the invention provide a precise selection of text and custom functionality to enhance a user's consumption of the HTML5 document.

As shown, the computer 102 includes an input device 104, an operating system 106, a web browser application 108, an application 109 comprising an interface module 116 and application components 110 such as selection modules 112 and HTML5 custom tool modules 114.

The computer 102 is an electronic device used by a user to perform tasks such as retrieving and viewing web pages hosted over a network, play music, etc. Examples of a computer 102 include but are not limited to a mobile telephone, tablet computer, a laptop computer, or a desktop computer. Thus, as used herein the term “computer” encompasses a wide variety of computing devices.

The computer 102 includes an input device 104 that generates input events 105 responsive to a user input. An input device 104 may be any device capable of receiving a user input, including for example, a touch sensitive display device or a mouse device. A touch-sensitive input device 104 is an electronic input system wherein a user can use his or her fingers, a stylus, and/or another object to provide user inputs. In one embodiment, the input device 104 includes a touch-sensitive display screen wherein a user can provide inputs by directly touching the touch-sensitive display screen. The input device generates touch events 105 based on the touch inputs received from the user. Similarly, a mouse input device receives user inputs and generates mouse input events 105 based on the received inputs.

Input events 105 include any input provided by the user on the input device 104. The touch events describe user inputs provided by the user using the touch-sensitive input device 104. Examples of touch input events generated by the touch-sensitive input device 104 include touch start, touch move, touch end, etc. Similarly, mouse events describe inputs generated by a mouse input device 104 and include mouse down, mouse move, mouse up events, etc. In one embodiment, the computer 102 sends the input events 105 to the operating system 106 executing on the computer 102.

The operating system 106 receives the touch events 105 and dispatches the touch events 105 to appropriate applications executing on the computer 102. The operating system 106 manages computer resources and provides common services enabling efficient execution of applications on the computer 102. Examples of the operating system 106 include variants of GOOGLE ANDROID, APPLE IOS, MICROSOFT WINDOWS, and LINUX. If a web browser application 108 has focus when an input event 105 is received, the operating system 106 directs the input event 105 to the web browser application 108.

The web browser application 108 is an application executing on the computer 102 and is typically used for retrieving and presenting resources accessed over a network. In one embodiment, the web browser application 108 is displaying a web page retrieved from a web server via a network. Examples of the web browser application 108 include, for example, GOOGLE CHROME, MOZILLA FIREFOX, APPLE SAFARI, and MICROSOFT INTERNET EXPLORER. A characteristic of web browser applications 108 is that they have limited access to computing resources of the computer 102. Typically, the operating system 106 limits access to operating system resources that various applications executing on the computer 102 may have. As such, applications such as the web browser application 108 do not have access to highlight tools for example that are included in the operating system; therefore, web browser applications 108 are not enabled to provide some functionality such as the highlight functionality to their users. Wherein the web browser application 108 receives an input event 105 from the operating system 106, the web browser application 108 may provide it to an application 109 if the web browser application has received HTML5 elements to display to a user.

The application 109 is an application executing on the computer 102 that may be a part of the web browser application 108 and is capable of interacting with an HTML5 document retrieved or displayed by the web browser application 108. In one embodiment, the application 109 is implemented as a widget in a web browser application 108. The application 109 may also be provided by an ereading platform and enabled to provide functionality associated with the ereading platform. The application 109 receives a user input from the web browser application 108 wherein a user has requested a document containing HTML5 elements or documents from an ereading platform domain. The application 109 includes one or more modules that provide functionality to a user. For example, selection modules 112 and the HTML5 custom tool modules 114 enable the application to provide a user with a functionality to select text within the HTML5 document responsive to an user input and highlight the selected text with a custom highlight color. In one embodiment, the application 109 identifies the input event 105 provided by the input device 104 and provide it to the selection module 112 if the input event is associated with selection operation. The application 109 may not provide the input event to the selection module 112 if the input event 105 is associated with, for example, a scroll or a pan operation.

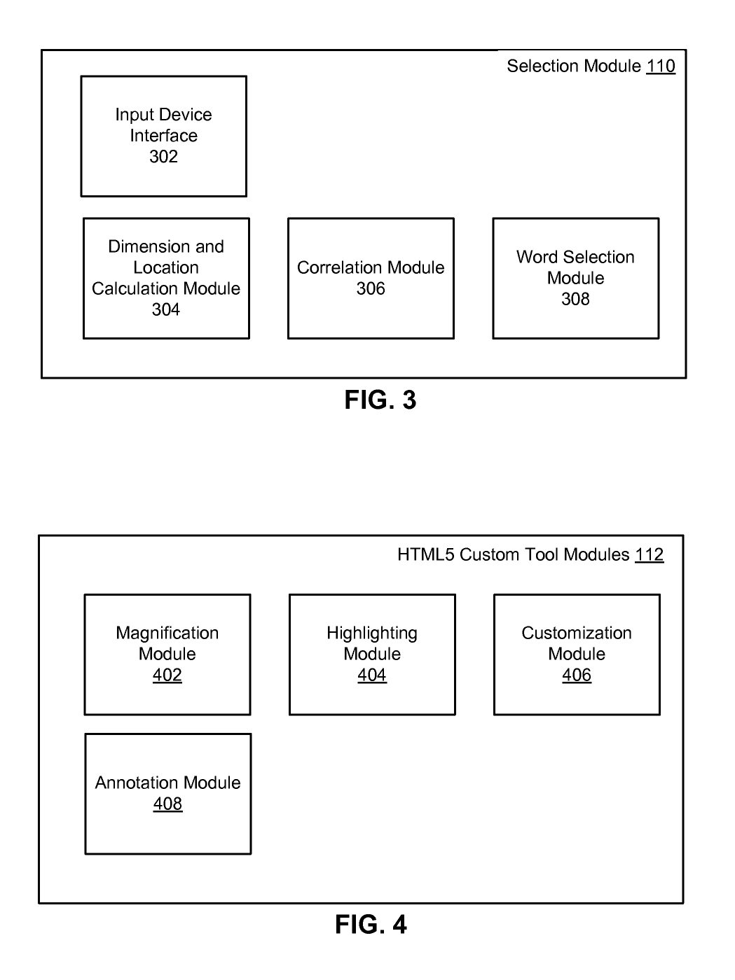

In one embodiment, the selection module 112 identifies text, including words, lines, paragraphs, etc., in an HTML5 page. Identifying such portions of an HTML5 document is typically problematic because an HTML5 document's cascading style sheets (CSS) do not define line breaking opportunities. To address this, the selection module 112 generates bounding boxes around each object in the HTML5 document and implements an algorithm as further described in reference to FIG. 3 of the specification.

In one embodiment, the selection module 112 also receives the input event 105 and calculates a boundary-point associated with the input event 105. A touch event, for example, includes a node and an offset wherein the node may identify the center of a user's touch and the offset area may identify other areas touched by the user. In one embodiment, the selection module 112 identifies wherein a user selection started and ended and identifies text the user intended to select based on the start and end points. As such, the selection module 112 identifies text selected by the user responsive to an input event 105.

The HTML5 custom tools module 114 provides tools to a user to enable the user to interact with an HTML5 document displayed on the web browser application 108. Examples of tools include, but are not limited to a magnifier and a highlighter. The tools provide custom functionality such as custom magnification levels, multiple magnifiers or different highlight colors. In one embodiment, the user is provided with a user interface wherein the user can select the tools and apply to the tool to a selected portion of the HTML5 document. HTML5 custom tools module 114 is described in greater details in reference to FIG. 4 of the specification.

The interface module 116 interfaces with application components 110 and the application 109. In one embodiment, the interface module 116 sends input events from an application and provides it to the application components 110 and receives outputs from the application components to provide to the application 109. As such, the interface module enables a sandbox environment for the application components 110. The tools in the application components 110 are isolated from the application and interface only with the interface module 116. The sandbox environment enables a digital platform publisher to allow users to define and create custom tools without providing access to the application 109. The interface module, therefore enables greater flexibility in creating and using custom tools in an application 109.

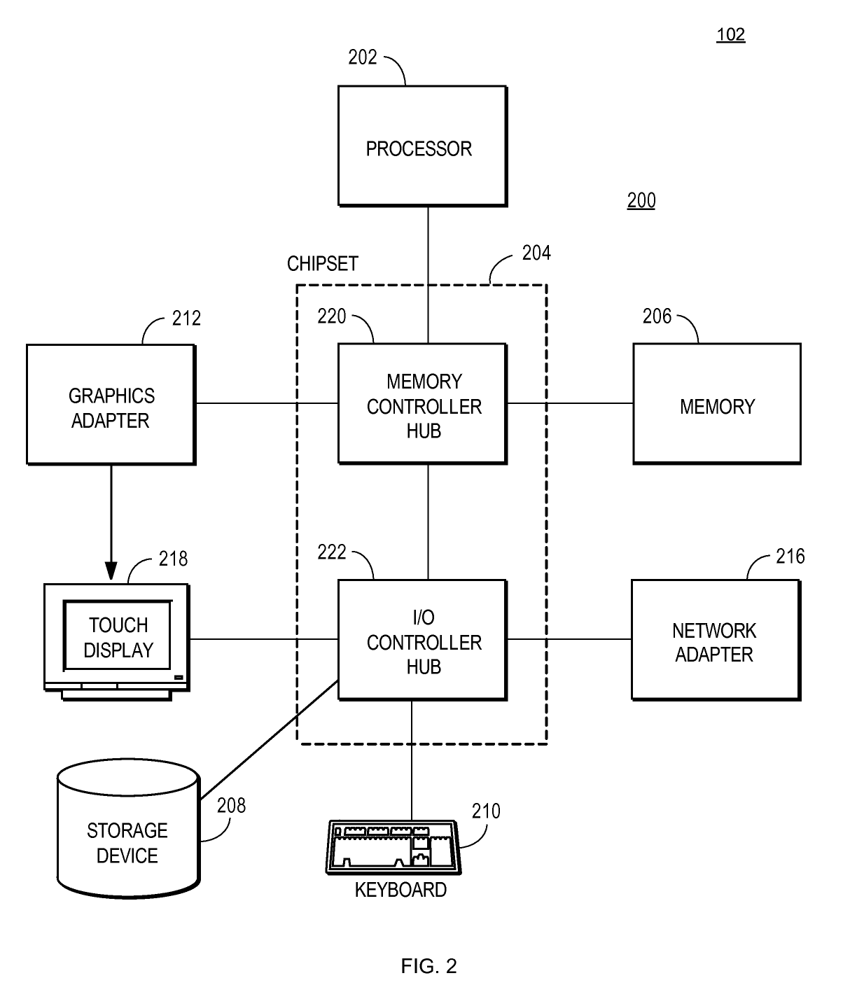

FIG. 2 is a high-level block diagram illustrating an example of a computer 102 according to one embodiment of the present disclosure. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213 and the I/O controller hub 255. A storage device 208, keyboard 210, and network adapter 216 are also coupled to the I/O controller hub 255. Other embodiments of the computer 102 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. In some embodiments, the display device 218 is a touch-sensitive display. The display device 218 can be used alone or in combination with the keyboard to input data to the computer 102. The graphics adapter 213 displays images and other information on the display device 218. The network adapter 216 couples the computer 102 to a network. Some embodiments of the computer 102 have different and/or other components than those shown in FIG. 2.

The computer 102 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

### System for Enabling Selection and Interaction

FIG. 3 illustrates a selection module 112 enabling a user to select text in an HTML5 document. The selection module 112 includes an input device interface 302, a dimension and location calculation module 304, a correlation module 306, and a word selection module 308.

The input device interface 302 receives an input event 105 from an application layer 109 or a web browser application 108. The input device interface 302 determines a type of input event provided by the user based on a type of input device 104 used by the user. For example, if a touch-sensitive input device is used, a touch down event that lasts a predetermined period of time may be considered a selection input. Similarly, if a mouse input device is used, a mouse down event followed by a mouse moved event is received, the input events 150 may be considered a selection input. As such, the input device interface 302 identifies a type of input event. Similarly, an end of selection is identified by the input device interface 302 when it receives a touch up event or a mouse up event for touch-sensitive inputs and mouse input devices respectively. Additionally, the input device interface 302 also identifies boundary points associated with the input event 105. A start anchor boundary point, for example, is a location where the selection input started and an end anchor boundary point is a location wherein the selection input ended. The start and end anchor boundary points are used by the correlation module 306 to identify text selected by the user.

The dimensions and location calculation module 304 identifies text in an HTML5 document, including for example, words, lines, paragraphs, columns, etc. on the page. The dimensions and location calculation module 304 identifies the text by generating bounding boxes that wrap around words, lines, paragraphs, etc. An algorithm is used to identify words based on the bounding boxes. For example, the dimensions and location calculation module 304 determines spatial separation or distances between characters on a page and identifies inter-character distances and inter-word distances. Based on the identified distances, the dimensions and location calculation module 304 identifies words on a page, wherein the words are characterized to start after a inter-word spacing distance and end before the next inter-word spacing distance. It is noted that the dimension and location calculation module 304 may identify such text and its properties in the background when a HTML5 code is received at the web browser application 108. In another embodiment, the dimension and location calculation module 304 may identify such text and its properties when a user provides an selection input. It is also noted that the dimension and location calculation module 304 may reside in a server on a network or at an ereading platform sending the HTML5 documents. For example, the ereading platform may identify words, lines, paragraphs, columns, etc. and provide such information in an HTML5 code such that the text and formatting information is already known when the HTML5 code is received at the web browser application 108.

The correlation module 306 correlates the user input identified at the input device interface 302 with an associated location on the HTML5 document displayed on the web browser application 108. As described in the specification, the input device interface 302 may indentify an input event type associated with a received input event 105; the correlation module 306 identifies the location of the input event 105 on the HTML5 document. Thus, in one embodiment, the correlation module 306 identifies the horizontal and vertical position of the input event 105 on the HTML5 document. In one embodiment, the correlation module also centers the input event 105 to a particular location on the HTML5 document. For example, if the input event 105 is a touch event, the area wherein a touch input is detected may be a large in diameter as a tip of the user's finger. In such an embodiment, the correlation module 306 calculates a center of the input. In other instances, the correlation module 306 may calculate a weighted center. The correlation module provides the location information to the word selection module 306.

The word selection module 306 identifies a word based on a type of user input, the location of a input and the corresponding location of the word. For example, if an input event is identified as a selection input, the word selection module matches the location of the selection input with a word at the same location. The word selection module 308 selects the word by highlighting the word. In one embodiment, the highlighted word may be displayed on the HTML5 document. Additionally, the word may be magnified and displayed to the user at a location above the selected word. The highlight and magnification interfaces are described in greater detail in reference to FIG. 4.

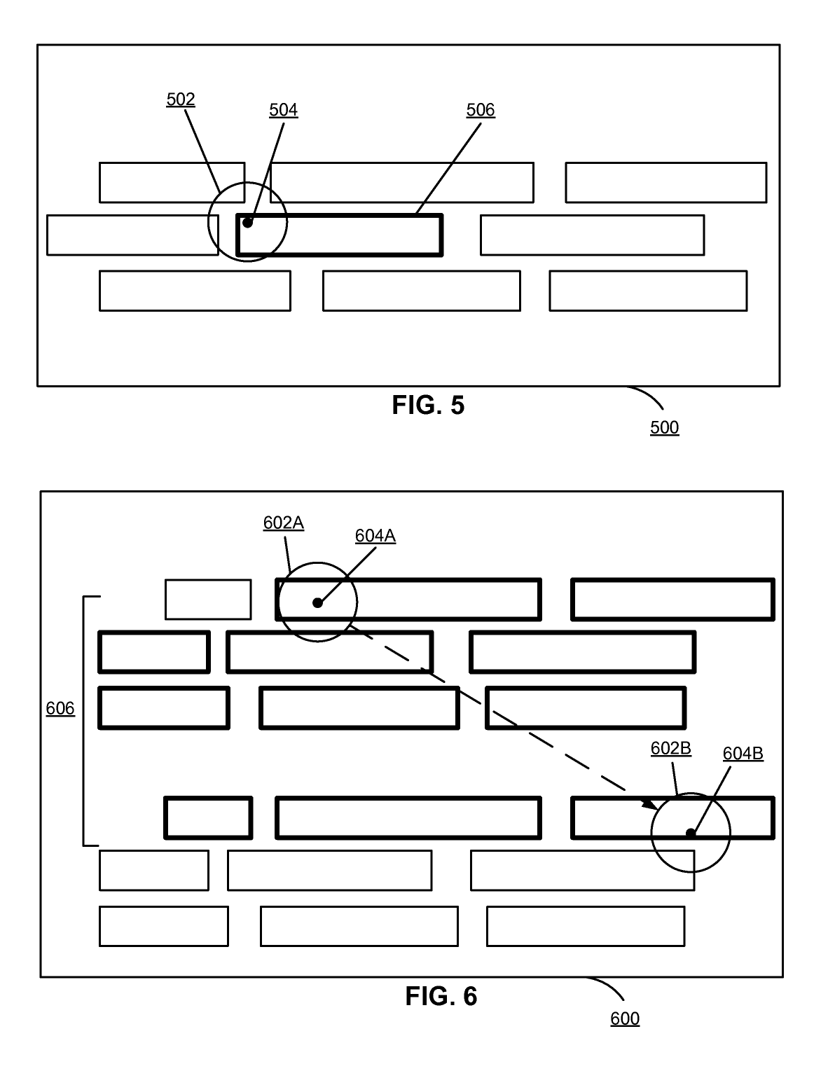

FIG. 5 is an illustration of selecting a word on an HTML5 page by touching and holding in accordance with an embodiment of the invention. FIG. 5 illustrates an HTML5 webpage 500, a touch input 502 input by a user, a center 504 of the touch input and a word 506 selected by the user. In one embodiment, a user provides a selection input by touching and holding the touch at a particular location on the HTML5 document. The selection module 110 selects a word 506 based on the user's touch input. As described in reference to FIG. 3, the input device interface receives the touch and hold input event and identifies it as a selection input event type, the correlation module identifies a location of the touch input event and identifies a center 504 of the touch input event. The dimension and location calculation module 304 identifies one or more words in the HTML5 webpage 500. The word selection engine 308 identifies a word 506 associated with the user's touch input based on the location of the touch input 502 and/or the center 504 calculated for the received touch input. In the example illustrated in FIG. 5, because the center 504 of the touch input 502 is located within the bounding box of word 506, the selection module 112 identifies a word 506 as being selected by the user. In other implementations, the selection module 112 identifies the closest word to the center 504 of the touch input 502, or may not register a selection of a word until the user has adjusted the touch input 502 so that the center 504 is within a bounding box of a word 506.

Referring again to FIG. 3, the modules within the selection module 112 identify an input event type, the input event's location within the HTML5 document and identify a word that is selected by the user's input each instance the user provides an input via the input device 104. As such, the selection module 112 is enabled to identify multiple words, sentences, paragraphs or columns of a page responsive to two or more user inputs. For example, if user selects a start word and continues to select additional words, the selection module 112 identifies each word selected by the user by iteratively receiving and processing each user input to identify the input event type, the input's location and the words selected by the input.

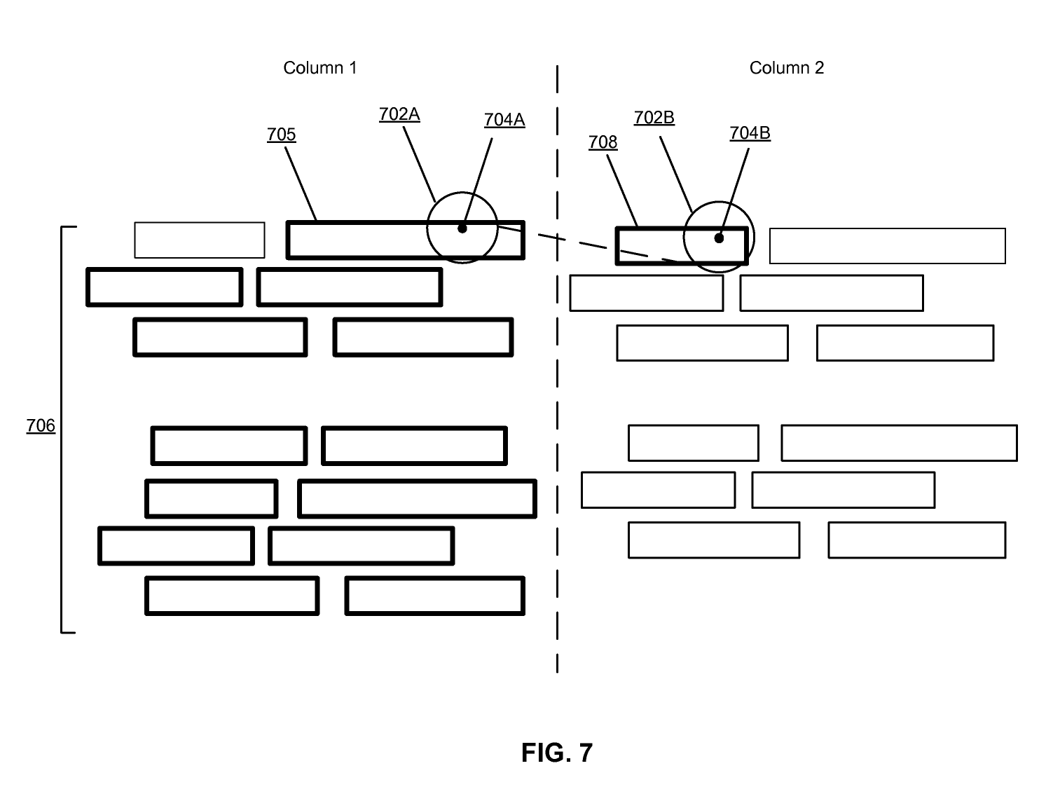

FIG. 6 is an illustration of a selecting content on an HTML5 page by touching and dragging in accordance with an embodiment of the invention. FIG. 6 illustrates an HTML5 webpage 600, touch inputs 602A and 602B, centers of the touch inputs 604A and 604B respectively and the words selected 606 by the touch inputs. As illustrated, a user drags a touch selection input 602A from one location to another location 602B on the HTML5 document. In one embodiment, responsive to the first selection input 602A, the selection module 112 identifies a selection input event type, the input's location, location of one or more words on the document, and selects a word 608 that correlates with the user's input. Thereafter, the user drags the touch input 602B to another location on the HTML5 document. Thereafter, the user drags the touch input 602B to another location on the HTML5 document. Responsive to the dragging input, the selection module 112 identifies a location wherein the dragging input ends and identifies a word associated with the input end location. In addition, the selection module identifies the words in between the input start and the input end events. The selection module 112 identifies the words between the input start and input end event by identifying words that are spatially in between the input start event and the input end event. In another embodiment, the selection module 112 identifies words in between the input start and end events based on line breaks, paragraph breaks, page breaks, column breaks, even if the words are not spatially between the input start and end events in the particular layout of the page 600. FIG. 7, described below, illustrates an instance wherein the selection module 112 uses a column break to identify words between an input start and an input end event.

FIG. 7 is an illustration of selecting content on a multi-columned HTLM5 page in accordance with an embodiment of the invention. As illustrated in FIG. 7, a user's touch start event 702A with center point 704A begins in column one and the touch end event 702B ends in column two. As described in the specification above, the selection module 112 identifies words that are selected by the touch start event 702A and the touch end event 702B. Additionally, the selection module 112 identifies words 706 that are between the first selected word 705 and the last selected word 708. However, if only geographic space between the words is used, then the selection module 112 would select only the first selected word 705 and the last selected word 708. However, the selection module 112 identifies the existence of a column break in the HTML5 document based on bounding boxes identified by the dimension and location calculation module 304. As such, the selection module 112 identifies all the words in column one after the first selected word 705 as existing between the first selected word 705 and the last selected word 708. Similarly, the selection module 112 may use other information identified by the dimension and location calculation module 304 such as words, lines, line lengths, paragraphs, columns etc., to appropriately identify words that a user wants to select. As such, the selection module 112 is enabled to identify the words intended to be selected by the user based on a variety page and text formatting properties.

FIG. 4 is a block diagram illustrating modules within HTML5 custom tool modules in accordance with an embodiment of the invention. The custom tool modules 114 include a magnification module 402, a highlighting module 404, an annotation module 406 and a customization module 408. The custom tools enable interaction with the content selected by the selection module 112. In one embodiment, the custom tools may be provided by an education digital reading platform providing the HTML5 page content. In other embodiments, the custom tools may be provided by a third-party. The tools may be stored and executed in an engine operating on the operating system 106, the web browser application 108 or the application 109. A user may download and install the custom tool or the custom tools may be pre-built in an application 109.

The magnification module 402 provides a tool enabling a user to magnify words selected by the user. In one embodiment, the magnification module 402 magnifies the words selected by the user via the input device 104 and displays the magnified words above the user's touch input. In one embodiment, the magnification module 402 may not provide the magnified text wherein a mouse input device is used. The magnification module works in substantially real time in conjunction with the selection module 112 to magnify each word that the user touches, as the user is touching it. For example, if a user is touching and dragging a touch input, the magnification module 402 provides magnification of a selected word at each instance a new coordinate or touch input event location is detected.

The highlight module 404 provides a tool enabling a user to highlight words selected by the user. In one embodiment, once one or more words are selected by the user, the HTML5 custom tool modules 114 provide a user interface requesting a user to select an action the user would like to perform on the selected text. Wherein the user selects a highlight option via the user interface, the highlight module 404 highlights the selected text. In one embodiment, the highlight module 404 highlights words or text in substantially real time as the user is providing a user input. For example, if a user selects a highlight tool and selects text as described in reference to FIG. 3, the highlight module 404 highlights each word as it is being selected by the user.

The annotation module 406 provides tools to a user to annotate the text displayed within the HTML5 document. Examples of annotation tools include, but are not limited to a copy tool, a cut tool, a note tool, etc. A note tool allows a user to add notes on the HTML5 document. The note may be presented to the user in a variety of user interfaces.

The customization module 408 provides customization to the magnification tool and the highlight tool. In one embodiment, customization for the magnification tool enables the user to set a magnification level. A magnification level may be a multiple of the current display size of the text. For example, a user may set the magnification level at twice or three times the current display size. Additionally, a user may customize the magnification tool to display the magnified text at a particular font size. For example, a user may select that the magnified text be displayed at a font size of 16. In one embodiment, a user may be provided with an option to select a number of magnification tools the user wants to use. In such an instance, the user may be provided with a predetermined number of magnifiers enabling the user to magnify several portions of a page. In another embodiment, the user can customize the shape of the magnification tool to be an oval, rectangle, or any closed shape. Additionally, the customization module 408 enables a user to customize the highlight tool. In one embodiment, the customization module 408 enables a user to select a color for the highlight tool.

### Process for Suggesting Connections

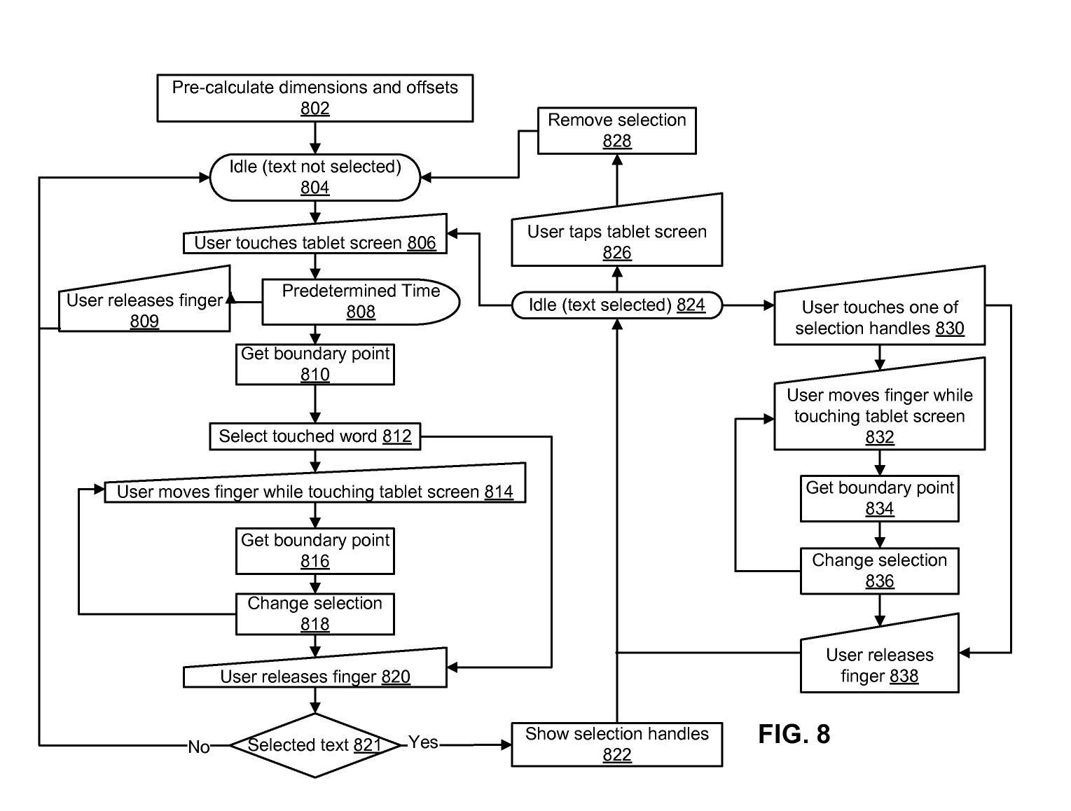

FIG. 8 is a diagram illustrating a process of selecting content responsive to touch input in accordance with an embodiment of the invention. In one embodiment, the process pre-calculates 802 dimensions and offsets of an HTML5 document. The pre-calculation 802 may comprise identifying words, lines, paragraphs, columns, etc., on a page retrieved by a web browser.

When a user does not provide a selection input, the process is idle 804. When a user touches 806 a computing device or a tablet computer screen, for a predetermined period of time 808, including for example, but not limited to 500 ms, the process gets 810 a boundary point. Boundary points include coordinates wherein the user provided the touch input on the tablet screen. Responsive to calculating the touch input's boundary points, the process selects 812 a word touched by the user. If the user releases 809 his or her finger before the predetermined period of time 808, the process returns to an idle state 804.

If the user moves 814 his or her finger while touching the tablet screen without releasing the finger, the process gets 816 a boundary point for new location where the user's touch is provided. If the user further moves 814 his or her finger while touching the table screen, the word selection is changed 818. The process is iteratively repeated until the user releases 820 his or her finger.

If one or more words are selected 821 based on boundary points of the touch input, then the words are selected and shown 822 with selection handles. If no words are selected, the process returns to an idle 804 state. Once the selection handles are shown 822, the system returns to an idle 824 state, wherein if the user taps 826 the tablet screen, the selection is removed 828 and the system returns to an idle 804 state. If on the other hand, the user touches 830 a selection handle and moves 832 his or her finger while touching the tablet screen, the process gets 834 a boundary point for wherein the selection handle is moved to. The process changes 836 the word selection based on the boundary point of the user's touch input. The process iteratively repeats until the user releases 838 his or her finger and to end the selection. The system returns to an idle 824 state as described in the specification above.

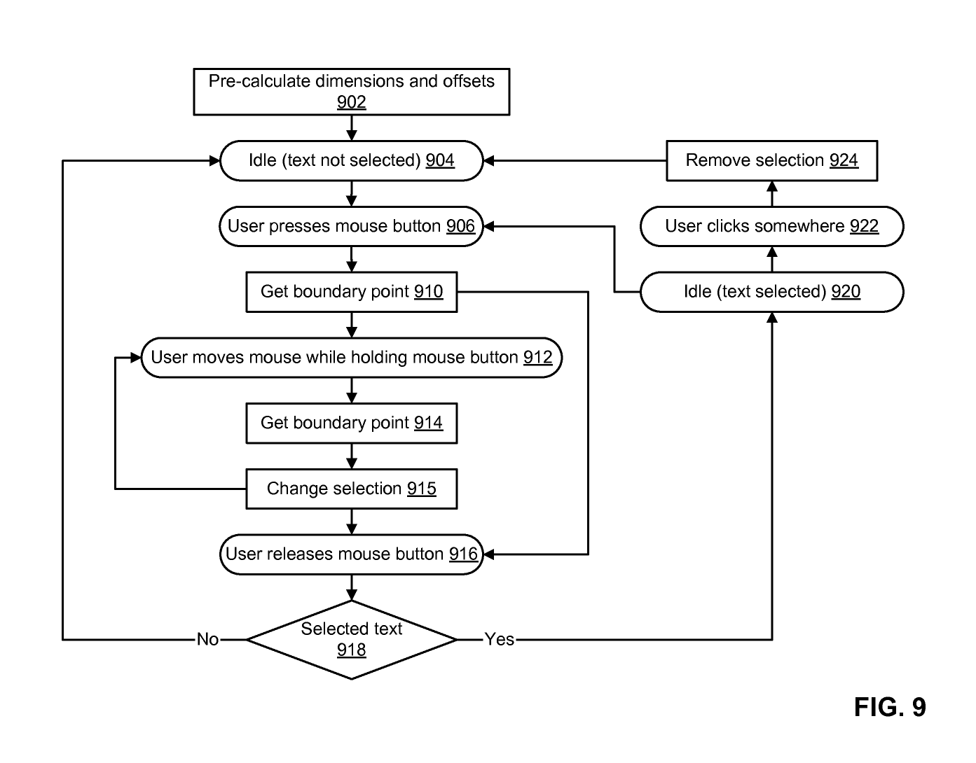

FIG. 9 is a diagram illustrating a process of selecting content responsive to a mouse input in accordance with an embodiment of the invention. The process pre-calculates 902 dimensions and offsets of an HTML5 document. The pre-calculation 902 may comprise identifying words, lines, paragraphs, columns, etc., on a page retrieved by a web browser.

When a user does not provide a selection input, the process is idle 904. When a user presses 906 a mouse button, the process gets 910 a boundary point. Boundary points include coordinates wherein the user provided the touch input on the tablet screen. If the user moves 912 the mouse while holding the mouse down, the process gets 914 a new boundary point corresponding with a new mouse or cursor location on a display device and changes the selection 915. The process iteratively repeats as the user moves the mouse while holding down the mouse button.

When the user releases 916 the mouse button, the process selects 918 words between the start and end boundary points. If no text is selected, i.e. there are no words between the start and end boundary points, the system is returned to an idle 904 state. If there are words between the boundary points, they are selected and the system is returned to an idle 920 state. If the user clicks 922 elsewhere, the word selection is removed 924 and the system is returned to an idle 904 state.

As such, embodiments of the invention enable a user to interact with an HTML5 document displayed on a web browser application executing on a computing device such as a computer, a tablet computer, an ereading device, a mobile phone, etc. Typically, web browsers do not have access to native resources that are available on an operating system; as such, web browsers do not offer a functionality enabling users to interact with a document displayed on the browser by highlighting it or magnifying text within the document. Embodiments described herein enable such functionality without accessing the operating system resources on a computing device. As described in the specification, the application 109 executing on a computing device identifies words or text a user wants to select based on bounding boxes and a interpretation of a user input provided by the user. Additionally, HTML5 custom tool modules 112 provide custom tools such as highlighting tools and magnification tools to enable a user to interact and annotate the HTML5 document displayed on the web browser application. Additionally, the tools are customizable to provide a more meaningful interactive user experience.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A computer implemented method of providing a custom selection functionality to a user of an application executing on a computing device, the method comprising:
intercepting an input directed to text displayed within a web application, the input generated responsive to a user interaction with an input device of the computing device;
interpreting the user input;
identifying input boundary conditions responsive to the interpreted input;
selecting words associated with the user input based on the identified boundary conditions;
displaying a user interface enabling a custom functionality provided by a web browser application.

2. The computer implemented method of claim 1, wherein the input device comprising at least one of a touch input device and a mouse input device.

3. The computer implemented method of claim 1, wherein interpreting the user input further comprising identifying a boundary point of the received user input.

4. The computer implemented method of claim 1, further comprising identifying at least one word on a document displayed to the user.

5. The computer implemented method of claim 1, further comprising correlating the user input with a word on a document displayed to the user, the word selected by the user input.

6. The computer implemented method of claim 1, wherein custom functionality comprises a magnification functionality, the magnification level selectable by the user.

7. The computer implemented method of claim 6, further comprising displaying the magnified text at a location above the magnified text.

8. The computer implemented method of claim 1, wherein custom functionality comprises a magnification functionality to display a magnified text, the magnified text displayed at a predetermined text size.

9. The computer implemented method of claim 1, wherein custom functionality comprises a magnification functionality displaying multiple magnification user interfaces to enable a user to magnify multiple portions of a page.

10. The computer implemented method of claim 1, wherein custom functionality comprises a highlighting functionality, the highlighting color selectable by a user.

11. A computer-readable storage medium storing executable computer program instructions for providing a custom selection functionality to a user of an application executing on a computing device, the computer program instructions comprising instructions for:
intercepting an input directed to text displayed within a web application, the input generated responsive to a user interaction with an input device of the computing device;
interpreting the user input;
identifying input boundary conditions responsive to the interpreted input;
selecting words associated with the user input based on the identified boundary conditions;
displaying a user interface enabling a custom functionality provided by a web browser application.

12. The computer-readable storage medium of claim 11, wherein the input device comprising at least one of a touch input device and a mouse input device.

13. The computer-readable storage medium of claim 11, wherein interpreting the user input further comprising identifying a boundary point of the received user input.

14. The computer-readable storage medium of claim 11, further comprising instructions for identifying at least one word on a document displayed to the user.

15. The computer-readable storage medium of claim 11, further comprising correlating the user input with a word on a document displayed to the user, the word selected by the user input.

16. The computer-readable storage medium of claim 11, wherein custom functionality comprises a magnification functionality, the magnification level selectable by the user.

17. The computer-readable storage medium of claim 11, further comprising displaying the magnified text at a location above the magnified text.

18. The computer-readable storage medium of claim 11, wherein custom functionality comprises a magnification functionality to display a magnified text, the magnified text displayed at a predetermined text size.

19. The computer-readable storage medium of claim 11, wherein custom functionality comprises a magnification functionality displaying multiple magnification user interfaces to enable a user to magnify multiple portions of a page.

20. The computer-readable storage medium of claim 11, wherein custom functionality comprises a highlighting functionality, the highlighting color selectable by a user.
